(19) United States
(12) Patent Application Publication
(10) Pub. No.: US 2022/0258364 A1
(43) Pub. Date: Aug. 18, 2022

(54) Method for Manufacturing Pairs of Scissors and Combination of At Least Two Pairs of Scissors

(71) Applicant: TransAtlanticSalesEurope GmbH, Solingen (DE)

(72) Inventor: Torsten Kretzer, Solingen (DE)

(21) Appl. No.: 17/617,960

(22) PCT Filed: May 11, 2020
(86) PCT No.: PCT/EP2020/063078

§ 371 Date: Dec. 10, 2021

(30) Foreign Application Priority Data
Jun. 21, 2019 (DE) 10 2019 116 772.8

(51) Int. Cl. B26B 13/20; B26B 13/28

(52) U.S. Cl. CPC B26B 13/20; B26B 13/28

(57) ABSTRACT

Manufacturing pairs of scissors, each pair including a first blade and a second blade, which are rotatably connected to one another by a fastening element, where each blade includes
a front end, a rear end opposite the front end,
a front portion extending towards the front end and forming a cutting element, and
a rear portion extending towards the rear end and provided to support a handle,
where the front portion of the first blade of at least one first pair of scissors and the front portion of the first blade of at least one second pair of scissors are designed differently, whereas the rear portion of the first blade of the first pair of scissors and the rear portion of the first blade of the second pair of scissors are designed identically.

### CROSS-REFERENCE TO RELATED APPLICATIONS

This application is the United States national phase of International Application No. PCT/EP2020/063078 filed May 11, 2020, and claims priority to German Patent Application No. 10 2019 116 772.8 filed Jun. 21, 2019, the disclosures of which are hereby incorporated by reference in their entirety.

### BACKGROUND OF THE DISCLOSURE

The disclosure relates to a method for manufacturing pairs of scissors, each pair of which comprises a first blade and a second blade which are rotatably connected by a fastening element, as well as to a combination of at least two such pairs of scissors.

### DESCRIPTION OF RELATED ART

The two blades of a pair of scissors are connected to one another by a fastening element, mostly in the form of a screw or a rivet. Each blade has a front end and a rear end opposite the front end. A front portion of each blade extends towards the front end and forms a cutting element. A rear portion of each blade extends towards the rear end and is provided to support a handle which may be injection molded or set onto the rear portion as an injection molded part, for example. The rear portion usually comprises a joint at which the two blades rub on each other when rotating about the fastening element. The rear portion to which the plastic handle is attached is referred to as a tang.

The design of the joint affects the cutting performance and the ease of movement. The design and the position of the tang affect the position of the individual handles relative to each other and thus affect the ergonomics of the scissors. Conventionally, depending on the size and application of the scissors, different designs of the rear portion are common, in particular because the blades are most often manufactured and ground individually. Differently designed joints cause different cutting performances of the scissors. Correspondingly, differently designed tangs have an effect on the attachment of the handle. As a consequence, when manufacturing the scissors, manual reworking is required, as are different workpiece holders in the further production process, such as, for example, in the injection molding tool and in the grinding processes.

### SUMMARY OF THE DISCLOSURE

It is an object of the disclosure to provide an improved method for manufacturing scissors, as well as to provide scissors that are easier to manufacture.

The method according to the present disclosure is defined by the features of claim 1. The combination of at least two scissors according to the disclosure is defined by each of the independent claims 6 and 7.

According to the disclosure, the front portion of the first blade of at least one first pair of scissors and the front portion of the first blade of at least one second pair of scissors are designed differently, whereas the rear portion of the first blade of the first pair of scissors and the rear portion of the first blade of the second pair of scissors are formed identically. Thus, with scissors having differently designed front portions or cutting elements, the rear portions of each of the first blade of the first and the second pair of scissors are formed identically. Here, the rear portions and in particular the tangs of the first and second blades of a pair of scissors may be designed differently, as long as the joints rub on each other. Thereby, asymmetric handle shapes become possible as well. Thus, scissors with cutting elements designed differently for different applications can be provided with the same handles at their rear portions and/or can be created with a reproducibly identical cutting performance with similarly designed joints.

Preferably, also the front portion of the second blade of the first pair of scissors and the front portion of the second blade of the second pair of scissors are designed differently, whereas the rear portion of the second blade of the first pair of scissors and the rear portion of the second blade of the second pair of scissors are formed identically. Here, the rear portions of the respective second blade of the first and second pair of scissors are also formed identically, whereas the front portions of the respective second blade of the first and second pair of scissors are designed differently. Advantageously, in particular the tangs of the respective first blades of both scissors, as well as the tangs of the respective second blades of both scissors are formed identically.

The front portion may extend from the fastening element up to the front end. Correspondingly, the rear portion can extend from the fastening element up to the rear end.

For the purposes of this disclosure, the front portion of each blade is a section of the blade extending to the front end of the blade. This may be, for example, the entire blade section from the fastening element up to the front end of the blade, or only a partial section thereof. Analogously, the rear portion denotes a section of the blade that extends up to the rear end thereof. The rear portion may be the entire blade section from the fastening element up to the rear end, or only a partial section thereof. Thus, it is decisive that a rear section of the first blade of the first pair of scissors designed for attaching a handle and a corresponding section of the first blade of the first pair of scissors and, if applicable, possible further scissors are identically designed so as to facilitate, in the case of a plurality of scissors with different blades or cutting elements, the manufacturing thereof by allowing handles to be attached to the identical sections of the respective blades using the same tools.

The first blade may be the upper blade or the lower blade of a respective pair of scissors. It is decisive that the second blade is the other blade of the respective pair of scissors. Accordingly, the second blade is the lower blade, if the first blade is the upper blade. Analogously, the second blade is the upper blade, if the first blade is the lower blade of each scissors.

The rear portion may comprise a tang designed for fastening a handle thereto, for example by injection molding or attaching a plastic handle or by forging, welding, or sintering a handle thereto. Here, the tang of the first blade of the first pair of scissors is formed identically to the tang of the first blade of the second pair of scissors. Correspondingly or alternatively, the tang of the second blade of the first pair of scissors can be formed identically to the tang of the second blade of the second pair of scissors.

The rear portion of each blade may comprise a joint, the joint of the first blade and the joint of the second blade of each scissors rubbing on each other when the two blades are rotated against each other and with respect to each other. Preferably, the joint of the first blade of the first pair of scissors is designed identically to the joint of the first blade of the second pair of scissors and/or the joint of the second blade of the first pair of scissors is designed identically to the joint of the second blade of the second pair of scissors.

Furthermore, the disclosure relates to a combination of at least two pairs of scissors manufactured by the method according to the disclosure.

### BRIEF DESCRIPTION OF THE DRAWINGS

Hereinafter, an embodiment of the disclosure will be explained in more detail with reference to the Figures. In the Figures:

FIG. 1 shows a first pair of scissors,

FIG. 2 shows the two blades of the first pair of scissors,

FIG. 3 shows a second pair of scissors,

FIG. 4 shows the two blades of the second pair of scissors,

FIG. 5 shows a third pair of scissors, and

FIG. 6 shows the two blades of the third pair of scissors.

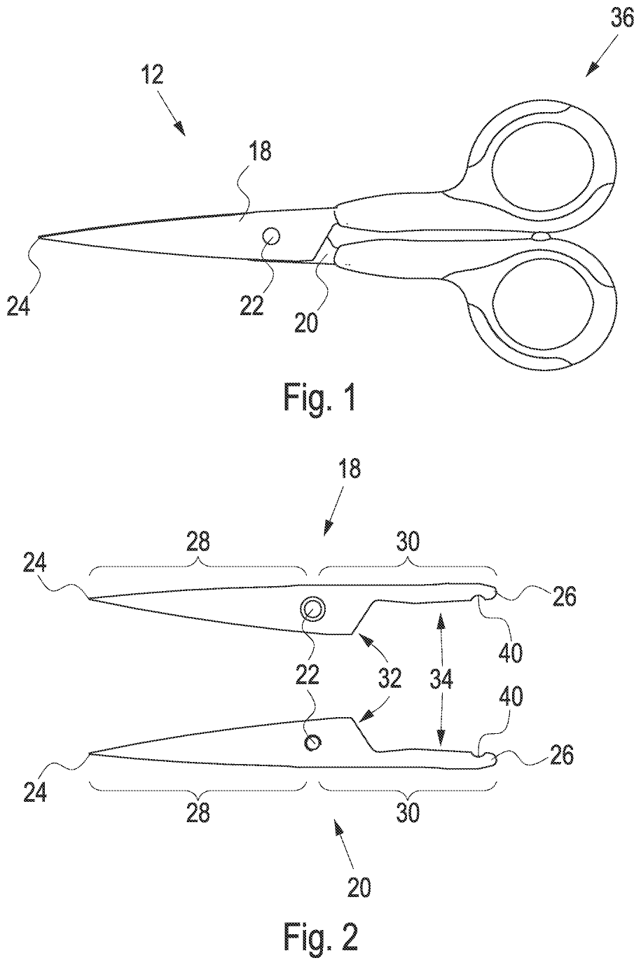

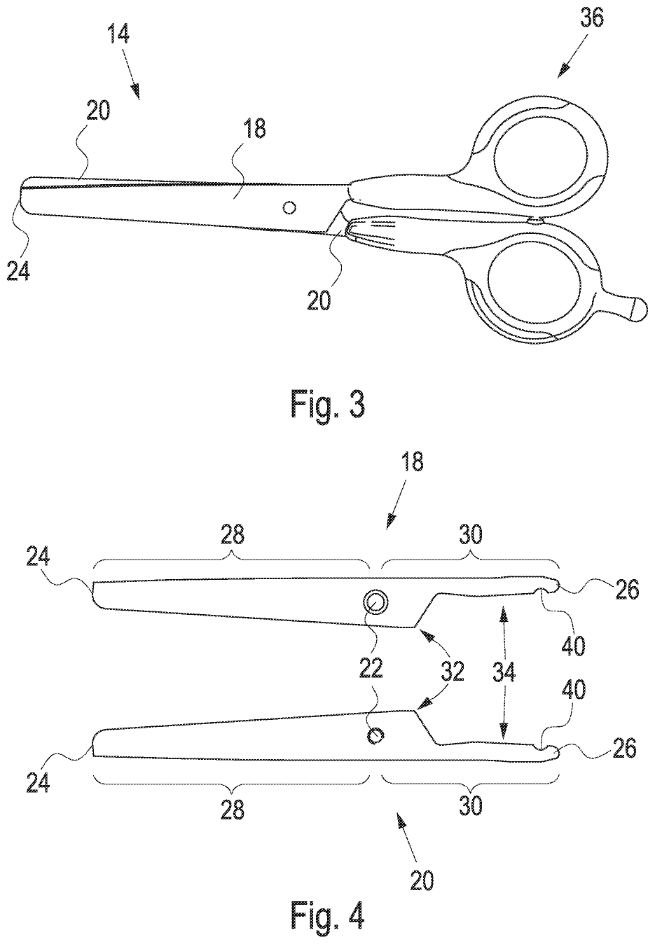

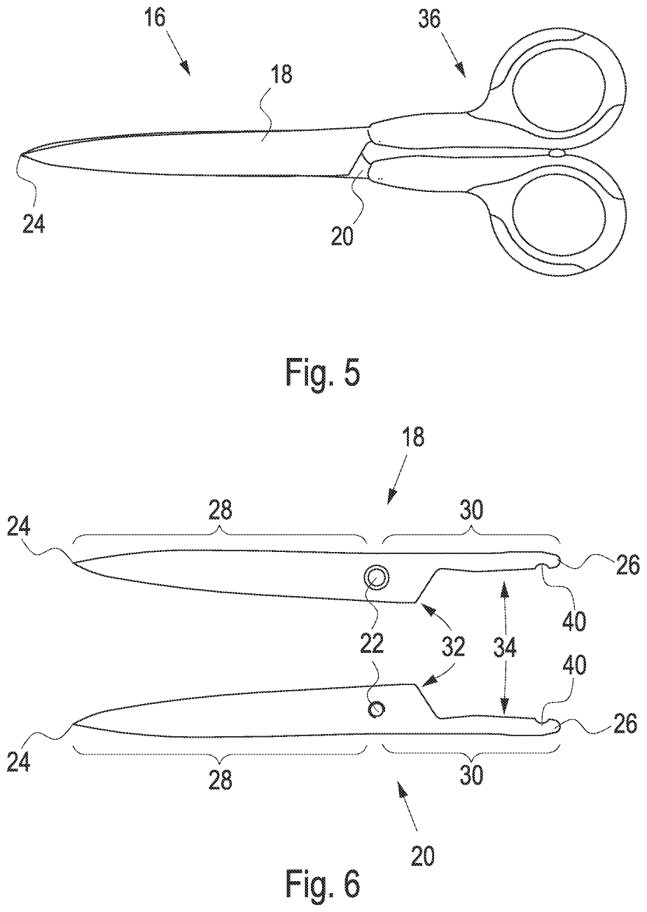

### DETAILED DESCRIPTION

Each of the three pairs of scissors 12, 14, 16 of the embodiment shown in the Figures comprises two blades 18, 20 which are connected to each other by a fastening element in the form of, for example, a screw, which is not illustrated in the Figures. Here, the fastening element is fastened, e.g. screwed, through the two fastening holes 22 illustrated in the Figures, the two blades 18, 20 being rotatable towards each other in the fastened and connected state.

Each of the two blades 18, 20 of each par of scissors has a front end 24 and a rear end 26 opposite the front end 24. A front portion 28 of each blade extends from the front end 24 up to the fastening opening 22. A rear portion 30 of each blade 18, 20 extends from the fastening opening 22 to the rear end 26. Each rear portion 30 has a joint 32 and a tang 34. The joints 32 of the two blades 18, 20 of each pair of scissors 12, 14, 16 are designed and arranged such that they rub on each other when the two blades 18, 20 are rotated towards each other.

The tang 34 is the section of each blade 18, 20 that extends between the joint 32 and the rear end 26 and has a comparatively small width and a shape that allows the attachment of a handle 36, e.g. by injection molding a plastic handle thereto. For this purpose, the tang 34 of each blade 18, 20 is provided with an indentation 40 that prevents the attached handle 36 from slipping off. Other designs of the shape of the tang 34 of the blades 18, 20, which allow for a suitable attachment of a handle 36 that prevents slipping of the handle 36, are also conceivable.

It can be seen in the Figures that the front sections 28 of the blades 18, 20 of each pair of scissors 12, 14, 16 are designed differently. The front sections 28 of the first pair of scissors 12 are designed to taper towards the front ends 24 and are designed with almost straight edges. The front sections 28 of the second pair of scissors 14 are formed rounded in the region of the front ends 24. The front sections 28 of the third pair of scissors 16 are designed to taper to the front ends 24 and are designed with curved edges.

In contrast, the rear portions 30 of the blades 18, 20 of each of the three pairs of scissors 12, 14, 16 are designed identically. As a consequence, also the joints 32 and the tangs 34 are identical. Each of the three pairs of scissors 12, 14, 16 thus shows identical friction and identical friction behavior between the joints. In addition, the same or similarly designed handles 36 can be attached, e.g. by an injection molding process, to the rear portions 30 of the three pairs of scissors 12, 14, 16, using the same manufacturing methods and the same manufacturing tools.

In the present context, “identically designed” or “identically formed” means that the size, shape, outer dimensions, and the course of the contour of the outer edge correspond to each other, i.e. are the same. In contrast, in the present context, “differently designed” or “differently formed” means that the size, shape, outer dimensions, and the course of the contour of the outer edge are different, i.e. differ from each other.

1. A method for manufacturing pairs of scissors, each pair comprising a first blade and a second blade, which are rotatably connected to one another by a fastening element, wherein each blade comprises
a front end, a rear end opposite the front end,
a front portion extending towards the front end and forming a cutting element, and
a rear portion extending towards the rear end and provided to support a handle,
wherein the front portion of the first blade of at least one first pair of scissors and the front portion of the first blade of at least one second pair of scissors are designed differently, whereas the rear portion of the first blade of the first pair of scissors and the rear portion of the first blade of the second pair of scissors are formed identically.

2. The method according to claim 1, wherein the front portion of the second blade of the first pair of scissors and the front portion of the second blade of the second pair of scissors are formed differently, whereas the rear portion of the second blade of the first pair of scissors and the rear portion of the second blade of the second pair of scissors are formed identically.

3. The method according to claim 1, wherein the front portion extends from the fastening element up to the front end and/or the rear portion extends from the fastening element up to the rear end.

4. The method according to claim 1, wherein the rear portion comprises a tang designed for fastening a handle thereto, wherein the tang of the first blade of the first pair of scissors is formed identically to the tang of the first blade of the second pair of scissors and/or the tang of the second blade of the first pair of scissors is formed identically to the tang of the second blade of the second pair of scissors.

5. The method according to claim 1, wherein
the rear portion comprises a joint, wherein the joint of the first blade and the joint of the second blade of each pair of scissors rub on each other when the two blades are rotated against each other, wherein the joint of the first blade of the first pair of scissors is formed identically to the joint of the first blade of the second pair of scissors and/or the joint of the second blade of the first pair of scissors is formed identically to the joint of the second blade of the second pair of scissors.

6. A combination of at least two pairs of scissors manufactured by the method according to claim 1.

7. The combination of at least two pairs of scissors, each pair comprising a first blade and a second blade, which are rotatably connected to one another by a fastening element, wherein each blade comprises
a front end, a rear end opposite the front end,
a front portion extending towards the front end and forming a cutting element, and
a rear portion extending towards the rear end and provided to support a handle,
wherein the front portion of the first blade of at least one first pair of scissors and the front portion of the first blade of at least one second pair of scissors are designed differently, whereas the rear portion of the first blade of the first pair of scissors and the rear portion of the first blade of the second pair of scissors are formed identically.

8. The combination according to claim 7, wherein the front portion of the second blade of the first pair of scissors and the front portion of the second blade of the second pair of scissors are formed differently, whereas the rear portion of the second blade of the first pair of scissors and the rear portion of the second blade of the second pair of scissors are formed identically.

9. The combination according to claim 1, wherein the front portion extends from the fastening element up to the front end and/or the rear portion extends from the fastening element up to the rear end.

10. The combination according to claim 1, wherein the rear portion comprises a tang designed for fastening a handle thereto, wherein the tang of the first blade of the first pair of scissors is formed identically to the tang of the first blade of the second pair of scissors and/or the tang of the second blade of the first pair of scissors is formed identically to the tang of the second blade of the second pair of scissors.

11. The combination according to claim 1, wherein the rear portion comprises a joint, wherein the joint of the first blade and the joint of the second blade of each pair of scissors rub on each other when the two blades are rotated against each other, wherein the joint of the first blade of the first pair of scissors is designed identically to the joint of the first blade of the second pair of scissors and/or the joint of the second blade of the first pair of scissors is designed identically to the joint of the second blade of the second pair of scissors.
